(19) United States
(12) Patent Application Publication
(10) Pub. No.: US 2014/0062236 A1
(43) Pub. Date: Mar. 6, 2014

(54) ROTATING ELECTRIC MACHINE DRIVE SYSTEM

(71) Applicant: DENSO CORPORATION, Kariya-city (JP)

(72) Inventors: Makoto TANIGUCHI, Obu-city (JP); Hiroki TOMIZAWA, Kariya-city (JP)

(73) Assignee: DENSO CORPORATION, Kariya-city (JP)

(21) Appl. No.: 14/016,313

(22) Filed: Sep. 3, 2013

(30) Foreign Application Priority Data
Sep. 6, 2012 (JP) 2012-196167

(51) Int. Cl. H02K 3/28

(52) U.S. Cl. CPC H02K 3/28
USPC 310/71

(57) ABSTRACT

A rotating electric machine drive system has a rotating electric machine and a controller positioned on an axial end of a rotating shaft of the rotating electric machine. The controller has a main current circuit board for flowing a main electric current. The system includes a conductor extending in a direction parallel to the rotating shaft of the rotating electric machine, serving as a stator winding wire, and connecting to the main current circuit board of the controller. In such a structure, a cross-sectional area of a terminal connection portion on an extension part of the conductor extending in a direction parallel to the rotating shaft is less than a cross-sectional area of a portion of the conductor within a plurality of conductor housings arranged on circumference of a stator of the rotating electric machine.

### CROSS-REFERENCE TO RELATED APPLICATION

This application is based on and claims the benefit of priority of Japanese Patent Application No. 2012-196167 filed on Sep. 6, 2012, the disclosure of which is incorporated herein by reference.

### TECHNICAL FIELD

The present disclosure relates to a rotating electric machine drive system for various types of brushless motors or synchronous generators.

### BACKGROUND

In recent years, advancements in semiconductor technology have resulted in the development of various types of implementation structures for so-called mechanism-and-circuit-in-a-single-body type rotating electric machines (i.e., rotating electric machines having a controller and a rotating mechanism integrated into a-single body). Further advancements have also led to the downsizing of rotating electric machines provided by the packaging of the controller circuit and the rotating mechanism within a high-density structure.

In particular, rotating electric machines and brushless motors have long been formed by using thick wires. The thick wires are wound in a few number of turns (i.e., coils) for the purpose of conducting a large electric current in the winding and yielding a high output. When such a thickly wound motor and controller are housed in a single body, devising a suitable connection structure for a motor winding wire and a power element in the controller circuit may be difficult. Further, the end of the wiring may have a metal terminal, such as a Faston terminal or a screw-fastening terminal, for connecting the wiring to other electrical components within the controller circuit. However, utilizing such terminals may increase the number of parts, the size and volume of the motor, and the cost.

Typically, an electrical connection structure connects the motor wiring to the power element in the controller circuit, as disclosed in a patent document 1 (i.e., Japanese Patent Laid-Open No. 2012-010576). The “connection” in this case and in the following indicates an electrical connection unless otherwise indicated.

When the technique disclosed in the patent document 1 is applied to a motor having the above-described thick wiring, a wire connection hole of a corresponding connector must have a larger diameter hole in order to accept the thick wiring. As a consequence, the size of an implementation area that is reserved or remaining for other electronic components may be reduced. Further, in recent years due to electro-magnetic interference caused by increased carrier frequency switching and drive electric currents, electromagnetic compatible (i.e., anti-electromagnetic interference) components must be positioned near the power circuit of the brush-less motor, thus demanding a larger implementation area.

### SUMMARY

It is an object of the present disclosure to provide a rotating electric machine drive system having thick wiring and a compact connection structure for connecting a control circuit and a rotating mechanism in a rotating electric machine.

In an aspect of the present disclosure, a rotating electric machine drive system has a rotating electric machine and a controller positioned on an axial end of a rotating shaft of the rotating electric machine. The controller has a main current circuit board for flowing a main electric current. The system includes a plurality of conductor housings that are arranged on a circumference of a stator of the rotating electric machine, and a conductor connected to the main current circuit board, housed in one of the plurality of conductor housings, extending in a direction parallel to the rotating shaft, and serving as a stator winding wire. The conductor has a terminal connection portion extending in the direction parallel to the rotating shaft, and the terminal connection portion of the conductor has a cross-sectional area that is less than a cross-sectional area of the conductor housed in one of the plurality of conductor housings.

By devising such a structure, the size and volume of the conductor and the associated connecting parts and structure of the main current circuit board are reduced, which provides for a larger effective implementation area on the main current circuit board. Therefore, if the rotating electric machine utilizes thick wiring to flow a large electric current, a compact connection structure may still be provided despite the use of thick wiring, such that a mechanism-and-circuit-in-a-single-body type rotating electric machines is created.

In addition to the above, the rotating electric machine drive system has the following configuration, that is the rotating electric machine includes a case member containing the stator of the rotating electric machine, a rotor co-axially positioned and rotatably disposed inside of the stator, and a rotating shaft attached to the rotor and rotatably supported by the case member. The main current circuit board is positioned on an axial end of the case member. Each of the plurality of conductor housings houses a plurality of conductors, and each of the conductors has a coil end part for connecting to another of the conductors housed in another conductor housing at predetermined intervals to create a phase winding wire. The coil end part in each phase provides a connection between the stator winding wires respectively in m (m is an integer of positive value) phases, and each of the conductors extend from the coil end part in the direction parallel to the rotating shaft and connect to the main current circuit board, a number of the conductors is defined as m multiplied by k (m*k), when a number of the conductor housings for each of the magnetic poles and for each of the m phases is designated as k (k: an integer of positive value).

In such a configuration, the conductors, at least a part of m multiplied by k, have a smaller volume at a position of connection to the main current circuit board, thereby providing a larger effective implementation area size on the main current circuit board. Therefore, if the rotating electric machine utilizes thick wiring to flow a large electric current, a compact connection structure may still be provided despite the use of thick wiring, such that a mechanism-and-circuit-in-a-single-body type rotating electric machines is created.

Further, the “rotating electric machine” may correspond to a motor, a generator, a motor generator and the like. The “conductor” may correspond to a material that conducts electricity, such as a bus bar, copper wire and the like. The “rotor” may have an arbitrary shape and is freely rotatable. Therefore, the shape of the rotor may be round or a round polygon, such as a cylinder, a cone (e.g., a truncated cone), a disk (e.g., a dish), a ring (e.g., a doughnut shape) or the like. The relationship between the stator and the rotor may also be arbitrary, and may include an inner-rotor type having the rotor positioned in an inside (i.e., a radial inner side) of the stator, or an outer-rotor type that having the rotor positioned on an outside (i.e., a radial outer side) of the stator.

### BRIEF DESCRIPTION OF THE DRAWINGS

Other objects, features and advantages of the present disclosure will become more apparent from the following detailed description disposed with reference to the accompanying drawings, in which:

FIG. 1 is an axial cross-sectional view of a rotating electric machine in a first embodiment of the present disclosure;

FIG. 2 is a radial cross-sectional view of the rotating electric machine in the first embodiment of the present disclosure;

FIG. 3 is an enlarged view of a stator in the first embodiment of the present disclosure;

FIG. 4 is a schematic diagram of a stator winding in the first embodiment of the present disclosure;

FIG. 5 is a combined partial cross-sectional plan view and partial cross-sectional side view of the rotating electric machine for showing a connection structure in the first embodiment of the present disclosure;

FIG. 6 is a schematic diagram of an electric circuit in the first embodiment of the present disclosure;

FIG. 7 is an enlarged combined partial top view and side view of a conductor terminal in the first embodiment of the present disclosure;

FIG. 8 is a combined partial cross-sectional plan view and partial cross-sectional side view of the rotating electric machine illustrating a connection structure in a second embodiment of the present disclosure;

FIG. 9 is a partial top view of a power module in the second embodiment of the present disclosure;

FIG. 10 is an enlarged combined partial top view and side view of the conductor terminal in a third embodiment;

FIG. 11 is a combined top view and side view of the rotating electric machine for showing a connection structure as a comparative example; and

FIG. 12 is a partial top view of the power module in a rotating electric machine as a comparative example.

### DETAILED DESCRIPTION

The following description details an embodiment of the present disclosure with reference to the drawings. Each of the drawings contains required parts for realizing the disclosure in a limited scope without necessarily containing all parts of a complete structure. The directions, orientations and the like are described with reference to arrows in the drawing.

### First Embodiment

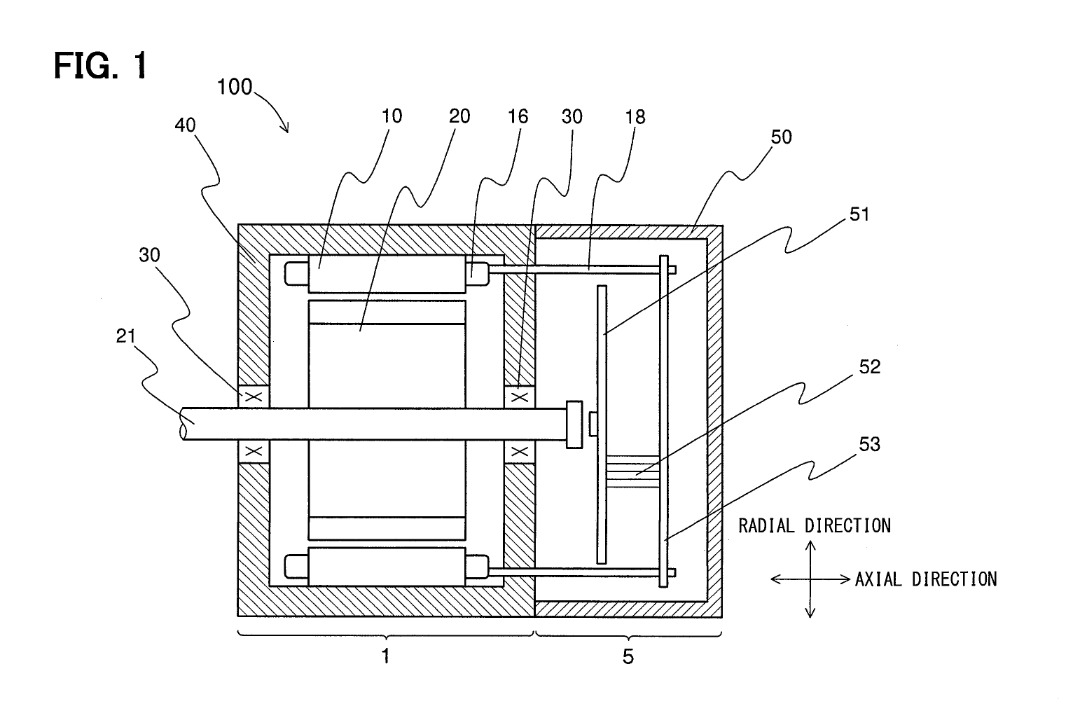

The first embodiment of the present disclosure is described with reference to FIG. 1 to FIG. 7. A rotating electric machine drive system 100 shown in FIG. 1 includes a rotating electric machine 1 and a controller 5. The rotating electric machine 1 and the controller 5 are combined to form a single body, such that the machine 1 and the controller 5 are aligned along the direction of a rotating shaft. That is, in other words, the controller 5 is arranged on one end of the rotating electric machine 1, as shown in FIG. 1.

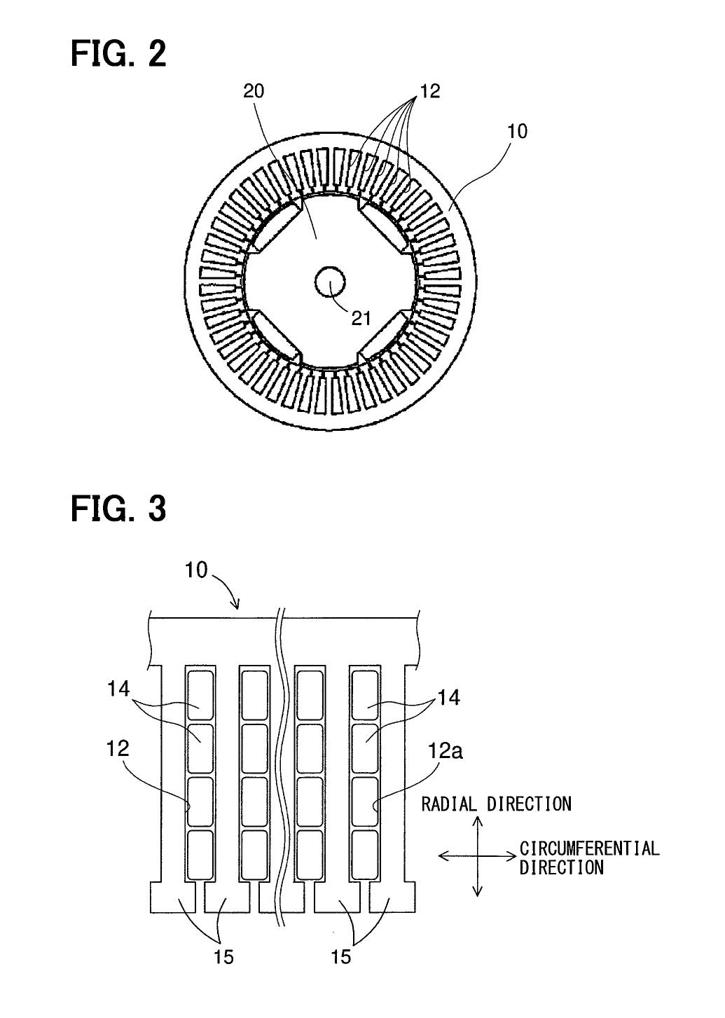

Referring to FIGS. 1 and 2, the rotating electric machine 1 has a stator 10, a rotor 20, a shaft 21, and the like inside of a case member 40. The case member 40 of the rotating electric machine 1 and a case member 50 of the controller 5 may be integrally formed (i.e., having a single body) or separately formed (i.e., having separate bodies with each body fastened to the other). If separately formed, the separate bodies may be fastened together by, for example, bolts/nuts, male/female screws, through-bores/cotter pins, welding, and/or caulking. Two or more of the above fastening means may be combined to fasten the case members 40, 50.

The above-described rotating electric machine 1 is depicted as an example of an inner rotor-type machine. The rotating shaft 21 is rotatably supported by the case member 40 through a bearing 30. The rotating shaft 21 may be fixed or molded at the center of the rotor 20. As a result, the rotating shaft 21 and the rotor 20 rotate together.

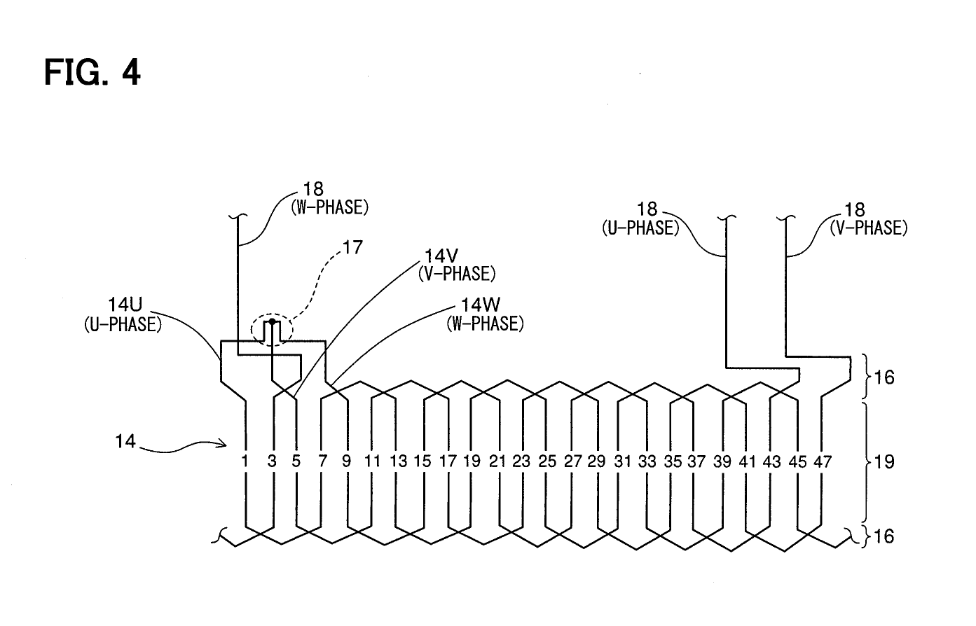

The stator 10 is formed in the shape of a cylinder and positioned around the rotor 20. As shown in FIGS. 2 and 3, the stator 10 has a plurality of conductor housings 12, or “slots” arranged on a circumference of the stator 10 and fixed onto the case member 40 by using the above-described fastening parts. The interval between the conductor housings 12 may be arbitrarily determined. However, a constant predetermined interval between each of the conductor housings 12 is preferable to provide an even magnetization and to increase the torque of the rotating electric machine 1. The conductor housings 12 may accommodate a plurality of conductors 14 (i.e., plural threads). The conductors 14 are positioned between teeth 15. For example, as shown in FIG. 3, four conductors 14 are arranged in a radial direction between the teeth 15. The portion of the conductor 14 positioned within the conductor housings 12 is hereinafter referred to as an “accommodated part 19” (see FIG. 4). The accommodated part 19 is aligned in the radial direction with respect to the rotating shaft 21. In contrast, the part of the conductor 14 protruding from the conductor housing 12 is referred to as a “coil end part 16” hereinafter. A portion of the coil end part 16 is formed as an extension part 18 extending in a direction parallel to the rotating shaft 21 from the conductors housing 12 and coil end part 16 toward a main current circuit board 53.

The controller 5 has a control circuit board 51 and a main current circuit board 53 housed inside of the case member 50. A signal line 52 establishes a connection between the control circuit board 51 and the main current circuit board 53. The signal line 52 may be implemented as any part, as long as the signal line 52 may transmit a signal. For example, the signal line 52 may be a connector, an electric wire, a cable or the like. The control circuit board 51 is connected to and capable of transmitting and receiving signals to and from an external device (not illustrated) such as an ECU, a computer or the like. The control circuit board 51 has a rotation sensor (not illustrated) for recognizing a rotation state of the rotating shaft 21, including a stop thereof, and, based on instruction information (e.g., a rotation instruction, a torque instruction and the like) of the external device, outputs the signal information through the signal line 52 for fulfilling a content of an instruction. The main current circuit board 53 is configured to flow an electric current to the conductors 14 in each of various phases based on the signal information transmitted from the control circuit board 51 through the signal line 52, and controls a rotation of the rotating shaft 21, including a stop thereof.

FIG. 4 illustrates a connection between the conductors 14. The conductor 14 is connected such that the conductor 14 has one “topological” line (i.e., to be formed as a no-branching line) in each of the multiple phases (i.e., any number of phases, equal to or more than two) serving as a stator winding wire of the rotation electric machine 1. More practically, one conductor 14 in one conductor housing 12 is connected to another conductor 14 in another conductor housing 12a to be formed as a stator winding wire of one phase, as shown in FIG. 3. In FIG. 4, an example of a wire connection is shown, in which the number of magnetic poles is 8, the number of phases is 3 (i.e., m=3), and the number of conductor housings for each of the magnetic poles and for each of the phases is defined as k=2. The total number of the conductor housings in this example is equal to 48, according to the following equation 48=8×3×2. Further, the number of the extension parts 18 is equal to 6, since 6=3×2.

The stator 10 includes two sets of three-phase winding wires as shown in FIG. 4, which are winding wires in a U-phase, a V-phase, and a W-phase and in an X-phase, a Y-phase, a Z-phase. In this example, every seventh conductor housing 12 accommodates a winding wire of the same phase. In FIG. 4, the numbering of the conductors 14 pertains to the conductor housing numbers regarding the winding wires in the three-phases, that is, the U/V/W phases (i.e., odd numbers between 1 and 48). The conductor housing number is a number of the conductor housings 12, for uniquely identifying each of the conductor housings 12.

Therefore, a U-phase winding wire 14U is made up of the conductors 14 respectively having conductor housing numbers of “1”, “7”, “13”, “19”, “25”, “31”, “37”, “43”, etc. A V-phase winding wire 14V is made up of the conductors 14 respectively having conductor housing numbers of “9”, “15”, “21”, “27”, “33”, “39”, “45”, etc. A W-phase winding wire 14W is made up of the conductors 14 respectively having conductor housing numbers of “5”, “11”, “17”, “23”, “29”, “35”, “41”, “47”, etc. Though not illustrated, the winding wires in the other three-phases, that is, X/Y/Z phases, also have the same connection structure as the U/V/W phases (i.e., numbered with even numbers between 1 and 48). For example, the winding wire in the X-phase is made up of the conductors 14 respectively having conductor housing numbers of “2”, “8”, “14”, “20”, “26”, “32”, “38”, “44”, etc.

Each of the three-phase winding wires (i.e., wires in a U-phase, a V-phase, a W-phase and in an X-phase, a Y-phase, a Z-phase) is a combination of a plurality of conductors 14 that are respectively connected to one another at the coil end part 16, housed in the respective housings 12, wound on the stator 10, and serving as one of a plurality of winding wires, respectively. One end of each of the three-phase winding wires is connected at one point to create a neutral point 17, and the other end of each of the three-phase winding wires serves as the extension part 18, or as a lead wire, to be extended toward the main current circuit board 53.

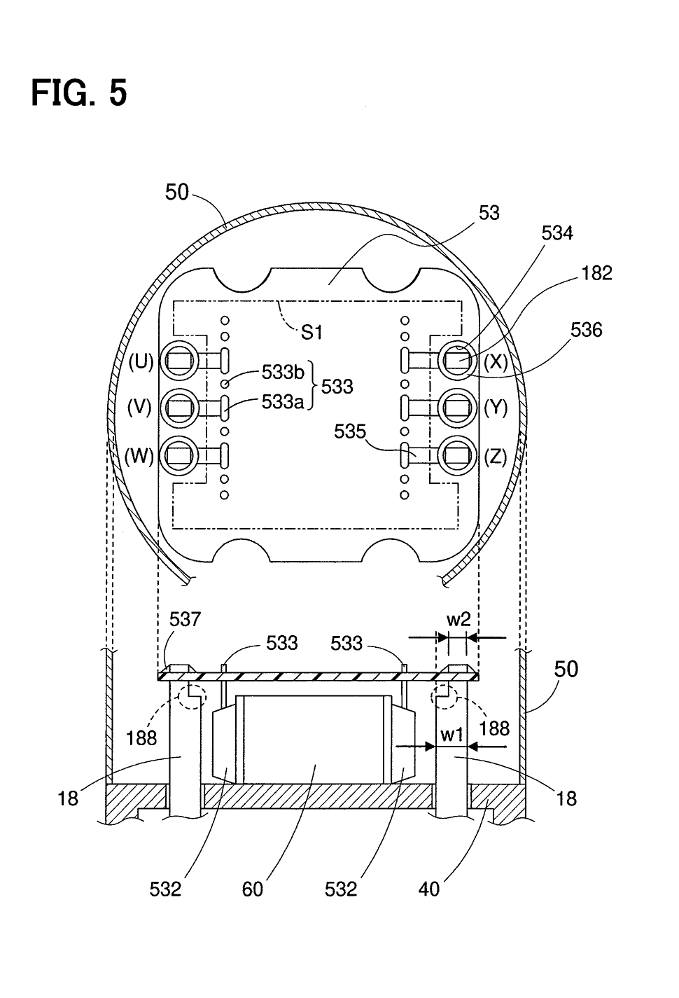

The extension part 18, which is a part of each of the conductors 14, extending in a direction parallel to the rotating shaft 21 from the coil end part 16 toward the controller 5. One extension part 18 is provided for one winding wire in each phase, thereby equating to six pieces of wires in six phases, which is made up as two sets of three-phases, as shown in FIG. 5. By having six phases instead of three-phases, the electric current flowing in one winding wire is reduced. If the conductor 14 is capable of flowing a large electric current, the number of phases may only be three (e.g., U-phase, V-phase, and W-phase).

FIG. 5 is an example of a connection structure between the stator winding wire (i.e., the extension part 18 of the conductor 14) and the controller 5. In FIG. 5, an upper part of the drawing is a partial cross-sectional plan view and a lower part of the drawing is a partial cross-sectional side view. A terminal connection portion 182, which is formed as an extended portion of the conductor 14, is configured to have a smaller cross-section than the cross-section of the conductor 14 within the conductor housing 12. That is, the cross-sectional area of the terminal connection portion is less than a cross-sectional area of a portion of the conductor 14 (i.e., a cross-sectional area of the accommodated part 19) within the conductor housings 12. The setting of the cross-sectional area is explained below as an example.

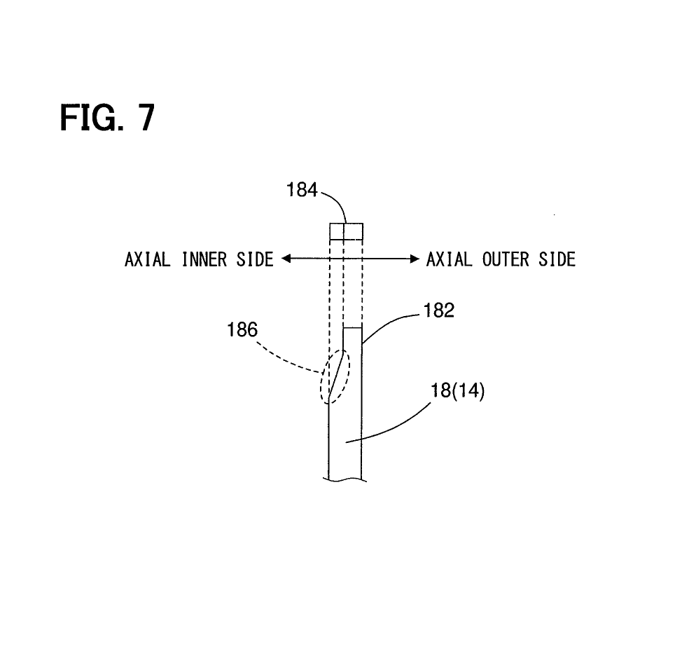

Referring to the top view in FIG. 7, the terminal connection portion 182 has a narrowed region on a side of the terminal connection portion 182 nearest to the rotating shaft 21 (i.e., along an axial inner side of the terminal connection portion 182). As a result, the width of the extension part 18 on a side 184 of the extension part 18 is narrowed and the cross-sectional area of the terminal connection portion 182 is reduced. In addition, the narrowed region of the terminal connection portion 182 may also be partially positioned on a side of the terminal connection portion 182 nearest the shaft such that the width and the cross-sectional area of the terminal connection portion 182 are decreased.

In FIG. 5, the narrowed region is formed as a notch 188 to reduce the cross-section area of the terminal connection portion 182. Preferably, the notch 188 reduces the width on the side 184 of the terminal connection portion 182 such that the cross-sectional area of the terminal connection portion 182 is decreased by 30% or more. The terminal connection portion 182 has a constant width along the side 184, which is defined as w1. The remaining width of the terminal connection portion 182 adjacent to the notch 188 is defined as w2. The widths w1 and w2 are configured to have the following relationship, 0.5*w1≦w2≦0.7*w1. The width w1 of the extension part 18 on the side 184 is the width of the accommodated part 19 of the conductor 14 housed in the housing part 12, as shown in FIG. 3, FIG. 4. The accommodated part 19 of the conductor 14 (i.e., the portion of conductor 14 housed in the conductor housing 12) has an electric current density of 11 [Arms/mm²] or more, by having a substantially-rectangular shape with a cross-sectional aspect ratio of 1:1.5 or greater in cross-section.

The narrowed region of the terminal connection portion 182 is formed on the axial inner side of the terminal connection portion 182 (i.e., an inner side of the terminal connection portion 182 nearest the rotating shaft 21) and on the end of the terminal connection portion 182 near a connection interface between the extension part 18 and the main current circuit board 53. The narrowed region is positioned as far along the outer periphery of the main current circuit board 53 as possible, in order to increase the size of an effective implementation area S1 on the main current circuit board 53, on which the electronic components are placed (i.e., the area within the double-dotted line as shown in FIG. 5). The terminal connection portion 182 of the extension part 18 is inserted into a through-hole 534 positioned on the main current circuit board 53, and is connected to the through-hole 534 by solder 537. The terminal connection portion 182 may also be welded onto the main current circuit board 53. The through-hole 534 of the present embodiment is formed in a round shape, and has a conductive part 536 connected to a wiring pattern 535 positioned on a surface of an inner wall of the through-hole 534. In other words, the through-hole 534 and the conductive part 536 may also be designated as a “land.” Therefore, the extension part 18 of the conductor 14 is inserted into the through-hole 534 and is connected to the conductive part 536 of the through-hole 534. A diameter of the through-hole 534 may be an arbitrary value but preferably sized according to the size of the terminal connection portion 182 for the ease of insertion and connection.

The main current circuit board 53 is connected to a power module 532. The power module 532 is implemented on the main current circuit board 53 by terminals 533. The power module 532 is fixed to a heat sink 60. The power module 532 used in a three-phase circuit is equivalent to a “power element” in claims, and may be a modularized power element bridge circuit. The power module 532 may include only semiconductor parts that are controlled by a signal from the main current circuit board 53 (e.g., switching elements, diodes, ICs, LSIs, etc.), or may include both semiconductor parts and non-semiconductor parts (e.g., resistors, coils, condensers, etc.). The switching element may be an FET (e.g., MOSFET, JFET, MESFET, etc.), an IGBT, a GTO, a power transistor or the like. In the present embodiment, two power modules 532 are provided as shown in the partial cross-sectional side view of FIG. 5, and each power module 532 is separately connected to the main current circuit board 53. The terminals 533 include a board shape terminal 533a that has a wide board shape with an increased width serving as a large electric current flow part. The terminals 533 also includes a pin terminal 533b (i.e., a rod-shaped terminal) as a signal line gate terminal, a sense terminal or the like, together with other kinds of terminals. As shown in parentheses in the partial cross-sectional plan view of FIG. 5, the arrangement of the phases (i.e., a U-phase, a V-phase, a W-phase, an X-phase, a Y-phase, and a Z-phase) are illustrated as an example.

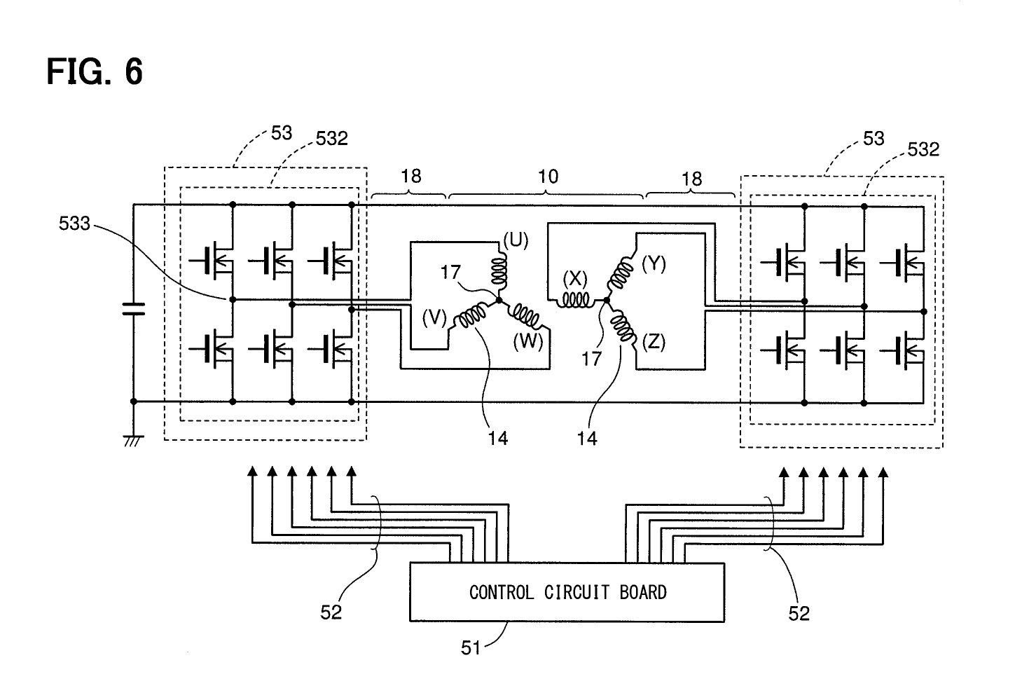

FIG. 6 shows an example of a connection structure between the main current circuit board 53, including the power module 532 and the conductor 14 of the stator 10. The control circuit board 51 receives a detection signal transmitted from various sensors such as a position sensor detecting a magnetic pole position of the rotor 20, an electric current sensor detecting an electric current flowing in the conductor 14 (i.e., in a stator winding wire), and the like. After receiving the detection signal, the control circuit board 51 generates and outputs a control signal to be provided for a switching element in the power module 532. A reflux diode (not illustrated) is connected in parallel with each of the switching elements. The control circuit board 51 uses an arithmetic unit implemented on the board (e.g., a CPU or the like) for performing a vector operation to generate the above-described control signal.

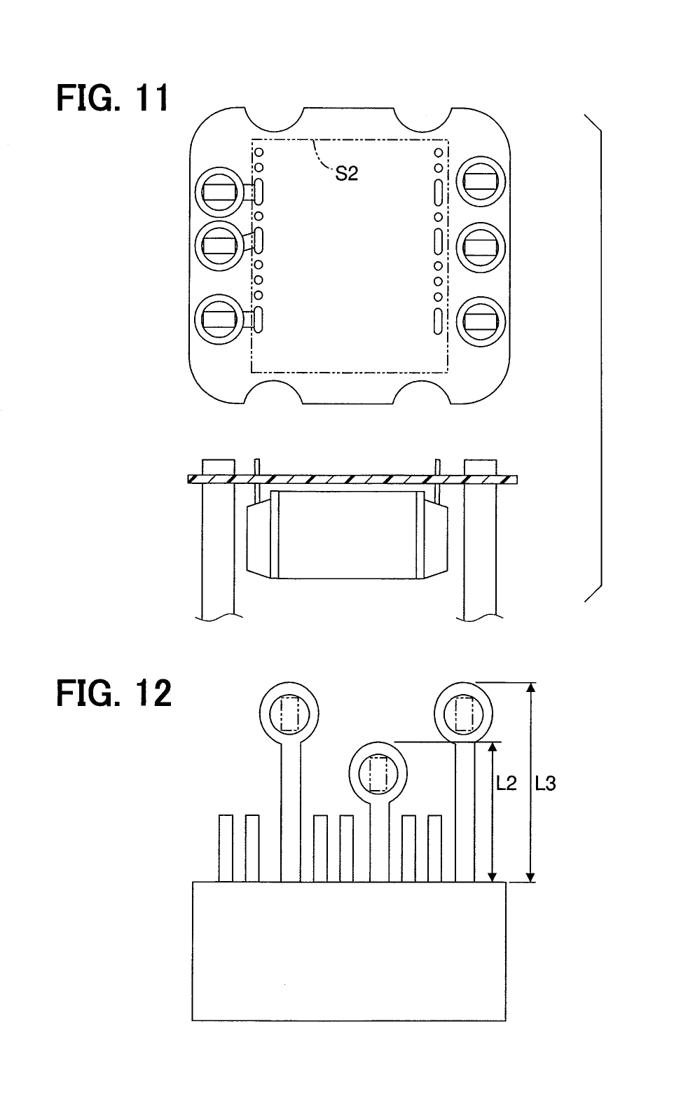

The rotating electric machine drive system 100 structured in the above-described manner produces a more reliable and compact system 100. In other words, when comparing the size of an effective implementation area S2 of the main current circuit board as a comparative example shown in FIG. 11 (i.e., a cross-sectional area within a double-dotted line), the size of the effective implementation area S1 on the main current circuit board 53 of the present embodiment in FIG. 5 is larger by about 20%. Therefore, the density of implementation on the main current circuit board 53 is increased, to allow an efficient arrangement of electromagnetic compatible (i.e., anti-electromagnetic interference) components, such as diodes, inductor elements and the like.

Referring to FIG. 7, the terminal connection portion 182 of the extension part 18 has a tapered region 186 for reducing the cross-sectional area of the extension part 18. The narrowed region of the terminal connection portion 182 in this case is also formed on the axial inner side of the terminal connection portion 182 (i.e., an inner side of the terminal connection portion 182 nearest the rotating shaft 21). The tapered region 186 also reduces a concentration of stress that may be caused by vibration of the conductor 14. Further, the tapered region 186 may have a flat shape, or a curved shape (e.g., concave or convex). The stress concentration reduction effectiveness may depend upon the slope or gradual tapering of the tapered region 186. In such a manner, the reliability of the power supply between the main current circuit board 53 and the power module 532 may be improved.

The following effects are expected from the first embodiment described above.

The rotating electric machine drive system 100 has a configuration, in which the terminal connection portion 182 of the conductor 14 narrows to reduce the cross-sectional area of the terminal connection portion 182 near the main current circuit board 53 relative to the cross-sectional area of the conductor 14 housed in the plurality of conductor housings 12 arranged on the circumference of the stator 10 of the rotating electric machine 1, as shown in FIG. 5 and FIG. 7. By devising such a configuration, the size of the conductor 14 is reduced at a position of connection to the main current circuit board 53, thereby providing a larger effective implementation area S1. Therefore, despite the use of thick conductors 14 (i.e., a thick wiring), a compact connection structure may be provided for a mechanism-and-circuit-in-one-body type rotating electric machine.

The rotating electric machine 1 includes the rotor 20 with its shaft 21 rotatably supported by the case member 40 through the bearing 30 and the stator 10 co-axially positioned with the rotor 20. The controller 5 includes the main current circuit board 53 positioned on an axial end of the case member 40 where the stator 10 is fixed and one conductor housing 12 houses a plurality of conductors 14. Each of the plurality of conductors 14 has the coil end part 16 connecting one of the conductors (14) to another of the conductors (14) housed in the other conductor housing 12a at predetermined intervals to create one of the phase winding wires. The coil end part 16 of the conductor 14 in each phase provides a connection between the winding wires respectively in m phases (m: an integer of positive value), and, when the number of the conductor housings for each of the magnetic poles and for each of the m phases is designated as k (k: an integer of positive value), the number of the conductors 14 that extend from the coil end part 16 in a direction parallel to the rotating shaft 21 and connected to the main current circuit board 53 is represented by m multiplied by k (i.e., m*k). The terminal connection portion 182 of the conductor 14 has a smaller cross-sectional area than the conductor 14 in the conductor housings 12, as shown in FIG. 5 and FIG. 7. By devising such a configuration, the conductor 14 that is connected to the main current circuit board 53 has a reduced volume at a position of connection, thereby providing a larger effective implementation area S1. Therefore, despite the use of thick conductors 14 (i.e., a thick wiring), a compact connection structure may be provided for a mechanism-and-circuit-in-one-body type rotating electric machine.

The conductor 14 has a configuration, which includes an electric current density of 11 [Arms/mm²] or more in the conductor housing 12 having an aspect ratio of 1:1.5 or greater in cross-section, as shown in FIGS. 4, 5, and 7. By devising such a configuration, the conductor 14 may conduct a large electric current.

The narrowed region of the terminal connection portion 182 of the conductor 14 decreases the width on the side 184 of the terminal connection portion 182 such that the cross-sectional area of the terminal connection portion 182 is decreased by 30% or more, as shown in FIG. 5 and FIG. 7. By devising such configuration, a larger effective implementation area S1 is provided on the main current circuit board 53.

The narrowed region of the terminal connection portion 182 of the conductor 14 is positioned on an axial inner side of the terminal connection portion 182 (i.e., an inner side of the terminal connection portion 182 nearest the rotating shaft 21). In addition, the narrowed region of the terminal connection portion 182 may also be partially positioned on a side of the terminal connection portion 182 nearest the shaft. By devising such a configuration, a larger effective implementation area S1 is provided on the main current circuit board 53.

Referring to FIG. 7, the terminal connection portion 182 of the conductor 14 includes the tapered region 186 in which the cross-sectional area gradually decreases on each of the conductors 14. As a result of the tapered region 186, the concentration of stress caused by the vibration of the conductor 14 is reduced, thereby improving the reliability of the power supply.

The conductors 14 housed in the conductor housings 12 are aligned in the radial direction with respect to the rotating shaft 21, as shown in FIG. 3. By devising such a configuration, the conductors 14 may be housed in the conductor housings 12, and the magnetic flux generated by the electric current flowing in the conductors 14 and directed from the aligned conductors 14 to the stator 10 (i.e., a magnetic core) may be improved.

The conductor 14 is configured to (a) be inserted into the through-hole 534 on the main current circuit board 53 that has the power module 532 (i.e., a power element) of the controller 5 implemented thereon, and (b) be connected to the conductive part 536 of the through-hole 534, to which the wiring pattern 535 is also connected for the connection to a desired power module 532 (i.e., a desired power element), as shown in FIG. 5. Therefore, despite the use of thick conductors 14 (i.e., a thick wiring) for flowing large electric current, a compact connection structure may be provided for a mechanism-and-circuit-in-one-body type rotating electric machine.

The through-hole 534 positioned on the main current circuit board 53 may have a round shape, as shown in FIG. 5. By devising such a configuration, the terminal connection portion 182 can be connected to the conductive part 536 through the through-hole 534 regardless of the shape of the terminal connection portion 182. Further, it should be understood by one of ordinary skill in the art that the through-hole 534 is not limited to a round shape and may include shapes, such as a square, a hexagonal or the like, such that the terminal connection portion 182 may be connected to the conductive part 536.

### Second Embodiment

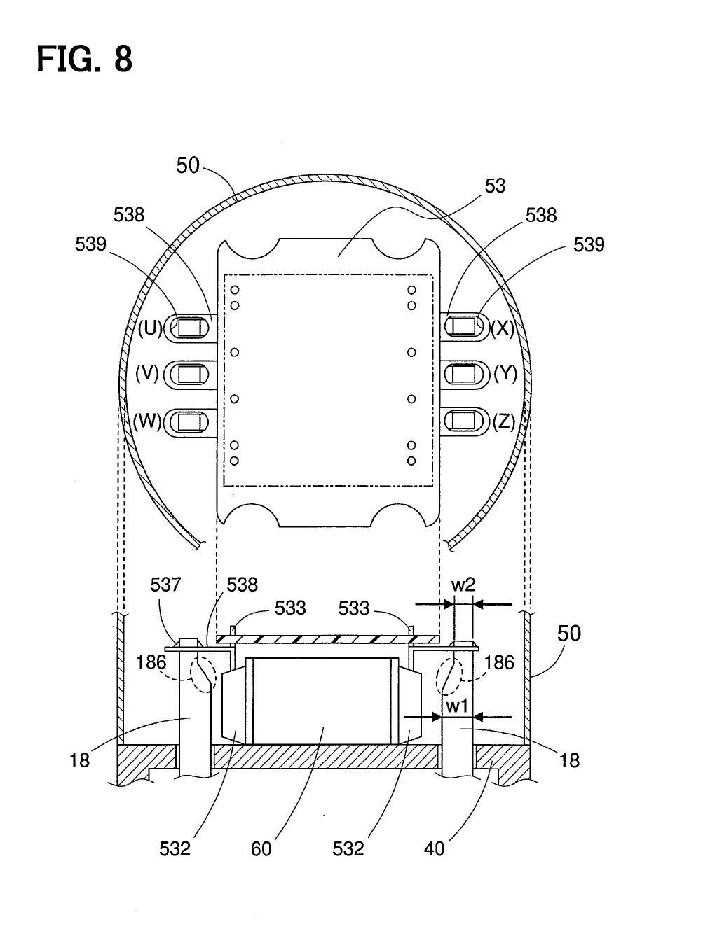

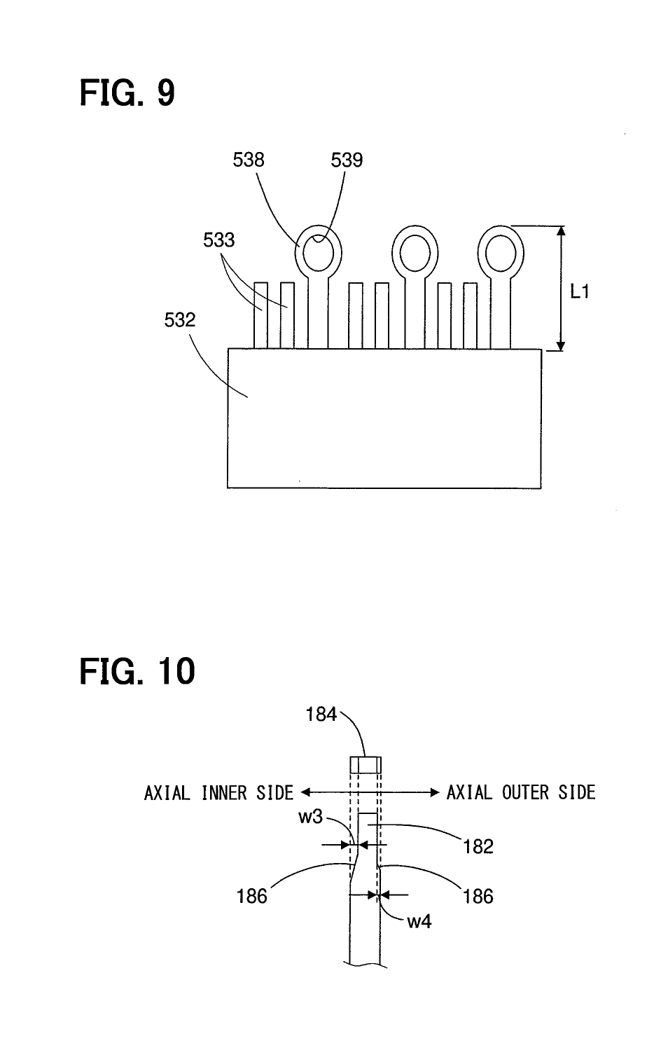

The second embodiment is described with reference to FIG. 8 and FIG. 9. The configuration of the rotating electric machine drive system 100 is similar to the first embodiment, and for brevity the following discussion focuses on the differences of the second embodiment from the first embodiment. Like parts have like numbers in the first and second embodiments.

FIG. 8 shows the second embodiment of the present disclosure, which replaces the configuration shown in FIG. 5. The second embodiment in FIG. 8 differs from the configuration in FIG. 5 such that the main current circuit board 53 is connected to a lead terminal 538 (i.e., may also be designated as a lead frame) without having the control circuit board 51 interposed between the main current circuit board 53 and the lead terminal 538. The lead terminal 538 is bent at a right angle into an L shape (e.g., about 90 degrees), and has a through-hole 539 on its end. The terminal connection portion 182 of the extension part 18 that is an extension of the conductor 14 may be inserted into the through-hole 539, and may be connected to the through-hole 539 by solder 537.

The diameter of the through-hole 539 formed on the lead terminal 538 may be reduced (i.e., the hole 539 is made smaller) by having a narrowed region on the terminal connection portion 182, as shown in the partial cross-sectional side view of FIG. 8. The narrowed region also allows the lead terminal 538 to have a standardized width such that manufacturing costs may be reduced. In FIG. 8, the terminal connection portion 182 is narrowed by the tapered region 186. However, the terminal connection portion 182 may also be narrowed by the step part 188 (i.e., the terminal connection portion 182 may have a narrowed region in the shape of a square/rectangular), as shown in FIG. 5.

FIG. 12 shows a shape of the lead terminals of the power module when the terminal connection portion is not narrowed. In comparison to the shape in FIG. 9, the lengths of the lead terminals are irregular in FIG. 12. As a result of the irregular shape, the production yield ratio of such a shape (i.e., during the manufacturing process) may low, which increases manufacturing costs relative to terminals having a more regular and simple shape. In contrast, the illustration of FIG. 9 depicts a pre-bent state of the lead terminal 538 which is formed on the terminal connection portion 182 of the conductor 14 and is in a pre-implementation state. The lead terminals are evenly prepared and have a length L1, as illustrated. In contrast, the lead terminals in FIG. 12 have to have two different lengths, (i.e., a length L2 and a length L3), which increases manufacturing costs.

The above-described advantages distinguish the second embodiment from the first embodiment. However, the second embodiment shares the same advantages of the first embodiment since other aspects of the second embodiment are the same as the first embodiment.

Referring to FIG. 8, the terminal connection portion 182 of the extension part 18 of the conductor 14 is inserted into and connected to the through-hole 539 located on the lead terminal 538 of the power module 532 (i.e., a modularized power element bridge circuit). By devising such a configuration, through-holes are not required on the main current circuit board 53 for the connection to the terminal connection portion 182. Therefore, a larger effective implementation area is created as shown by double-dotted line in FIG. 8.

### Third Embodiment

The third embodiment is described with reference to FIG. 10. The configuration of the rotating electric machine drive system 100 is similar to the first and second embodiments, and for brevity the following discussion focuses on the differences between the third embodiment and the first and second embodiments. Thus, like parts have like numbers between the first, second, and third embodiments.

The terminal connection portion 182 of the extension part 18 of the conductor 14 has a narrowed region similar to the step part 188 of the first embodiment on the axial inner side of the terminal connection portion 182 (i.e., an inner side of the terminal connection portion 182 nearest the rotating shaft 21), for the reduction of the size of the cross-sectional area. Similarly, in the second embodiment, the tapered region 186 is formed on an axial inner side of the extension part 18 in the radial direction for reducing the size of the cross-sectional area, as shown in FIG. 8.

In the third embodiment, the size reduction of the cross-sectional area is greater than the first and second embodiment due to the removal of a larger portion of the terminal connection portion 182. That is, as shown in FIG. 10, the tapered region 186 is formed on both sides (i.e., on an axial inner side and on an outer axial side) of the terminal connection portion 182 in the radial direction, by removing two parts from the terminal connection portion 182. Though not illustrated, alternatively, the narrowed region may have a shape similar to the step part 188, as shown in the first embodiment. In such a manner, an insulation film or the like, on both sides of the terminal connection portion 182 is securely removed therefrom. For the closer positioning of the through-hole 534 toward the periphery of the main current circuit board 53 (see FIG. 5), the width of the narrowed region on the axial inner side (i.e., a width w3 on the side 184) may be longer than the narrowed region on the outer axial side (i.e., a width w4 on the side 184). That is, the width w3 may be greater than the width w4 (i.e., w3>w4).

According to the third embodiment described above, since the terminal connection portion 182 has a further reduced cross-sectional area, the diameter of the through-hole on the main current circuit board 53 and on the lead terminal 538 may also be reduced. As a result, the effective implementation area S1 is increased, as shown in FIG. 5. Further, since the configuration of the other parts of the rotating electric machine drive system 100 of the third embodiment is the same as in the first and the second embodiments, the third embodiment shares the same advantages of the first and the second embodiment.

### Other Embodiments

Although the present disclosure has been fully described in connection with the above embodiment thereof with reference to the accompanying drawings, it is to be noted that various changes and modifications will become apparent to those skilled in the art.

For example, the following alternatives may be devised.

In the first, second, and third embodiments described above, the rotating electric machine 1 is described as an inner-rotor type, as shown in FIG. 1. However, the rotating electric machine drive system 100 may be applicable to an outer-rotor type rotating electric machine 1 benefitting from the same effects of the first, second, and third embodiments achieved by the system 100 of the present disclosure.

In the first, second, and third embodiments described above, the terminal connection portion 182 of the extension part 18 of the conductor 14 has a decreased cross-sectional area, with the cross-sectional shape of the terminal connection portion 182 unchanged from the rectangular shape, as shown in FIGS. 5, 7, and 10. As an alternative, the terminal connection portion 182 may include other cross-sectional shapes, by utilizing the narrowed region to form other shapes. For example, the terminal connection portion 182 may have a round or ovular shape, a rectangular shape with its longer and shorter sides reversed, a polygonal shape (e.g., a hexagon) or the like. Since such changes similarly reduce the size of the cross-sectional area of the terminal connection portion 182, the same effects are achieved as the first, second, and third embodiments.

In the first, second, and third embodiments described above, the step part 188 reduces the cross-sectional area of the terminal connection portion 182, as shown in FIG. 5. Alternatively, the step part 188 may be formed to include two or more steps. As the number of steps increases, the height of each step is reduced. Therefore, the result of the multiple steps may achieve similar effects as the tapered region 186 of the second embodiment, as shown in FIG. 7.

Such changes and modifications are to be understood as being within the scope of the present disclosure as defined by the appended claims.

What is claimed is:

1. A rotating electric machine drive system, the system having a rotating electric machine and a controller positioned on an axial end of a rotating shaft of the rotating electric machine, the controller having a main current circuit board for flowing a main electric current, the system comprising:
a plurality of conductor housings arranged on a circumference of a stator of the rotating electric machine; and
a conductor connected to the main current circuit board, housed in one of the plurality of conductor housings, extending in a direction parallel to the rotating shaft, and serving as a stator winding wire, wherein
the conductor has a terminal connection portion extending in the direction parallel to the rotating shaft, and
the terminal connection portion of the conductor has a cross-sectional area that is less than a cross-sectional area of the conductor housed in one of the plurality of conductor housings.

2. A rotating electric machine drive system of claim 1, wherein
the rotating electric machine includes
a case member containing the stator of the rotating electric machine,
a rotor co-axially positioned and rotatably disposed inside of the stator,
a rotating shaft attached to the rotor and rotatably supported by the case member,
the main current circuit board positioned on an axial end of the case member,
each of the plurality of conductor housings that house a plurality of conductors,
each of the conductors has a coil end part for connecting to another of the conductors housed in another conductor housing at predetermined intervals to create a phase winding wire,
the coil end part in each phase provides a connection between the stator winding wires respectively in m (m is an integer of positive value) phases, and
each of the conductors extend from the coil end part in the direction parallel to the rotating shaft and connect to the main current circuit board, a number of the conductors is defined as m multiplied by k (m*k), when a number of the conductor housings for each of the magnetic poles and for each of the m phases is designated as k (k: an integer of positive value).

3. The rotating electric machine drive system of claim 1, wherein
the conductor housed in one of the plurality of conductor housings has an electric current density of 11 Arms/mm² and an aspect ratio of 1:1.5 or greater in cross-section.

4. The rotating electric machine drive system of claim 1, wherein
the terminal connection portion has a narrowed region to decrease a cross-sectional area of the terminal connection portion by 30% or more.

5. The rotating electric machine drive system of claim 4, wherein
the narrowed region of the terminal connection portion is partially positioned on a side of the terminal connection portion nearest the rotating shaft.

6. The rotating electric machine drive system of claim 1, wherein
the terminal connection portion has a tapered region for reducing the cross-sectional area of the conductor.

7. The rotating electric machine drive system of claim 1, wherein
the conductor housed in one of the plurality of conductor housings is aligned in the radial direction with respect to the rotating shaft.

8. The rotating electric machine drive system of claim 1, further comprising:
a power module implemented on the main current circuit board;
a through-hole positioned on the main current circuit board and having a conductive part; and
a wiring pattern connected to the conductive part and a desired power element, wherein
the conductor is inserted into the through-hole and connected to the conductive part of the through-hole.

9. The rotating electric machine drive system of claim 8, wherein
the through-hole on the main current circuit board has a round shape.

10. The rotating electric machine drive system of claim 1, wherein
the conductor is inserted into and connected to a through-hole located on a lead terminal of a modularized power element bridge circuit.
